(19) United States
(12) Patent Application Publication
(10) Pub. No.: US 2014/0129421 A1
(43) Pub. Date: May 8, 2014

(54) Method and Apparatus for Searching and Acquiring Whole Loans

(71) Applicant: John Turnham, Thousand Oaks, CA (US)

(72) Inventor: John Turnham, Thousand Oaks, CA (US)

(21) Appl. No.: 13/672,522

(22) Filed: Nov. 8, 2012

(51) Int. Cl. G06Q 40/02

(52) U.S. Cl. CPC G06Q 40/025
USPC 705/38

(57) ABSTRACT

My invention provides a single, centralized platform for all banks to exchange whole loans. The platform provides banks with tools to perform these transactions securely, more efficiently, and in a more organized manner, while also giving users more tools with which to evaluate the loans. The tools for offering loans, searching, bidding, and counter-bidding, combined with analytical tools for assessing participant and marketplace performance creates a comprehensive mortgage trading environment which the industry lacks. These tools allow smaller banks to quickly build their Community Reinvestment Act portfolio, while larger banks also profit from the transactions. Trading is accomplished in real time so that all participants can have access to essential information.

I have invented a computer driven platform for seller financial institutions to list residential and commercial mortgages that they wish to transfer and for buyer financial institutions to select from the available loans on a centralized system that allows for competitive bidding and confirmation of results, with a goal of promoting compliance with Community Reinvestment Act (CRA), 29 U.S.C. 2901 et seq.

### CROSS-REFERENCES

None.

### STATEMENT REGARDING FEDERALLY-SPONSORED RESEARCH OR DEVELOPMENT

None.

### NAMES OF PARTIES TO A JOINT RESEARCH AGREEMENT

None.

### REFERENCE TO “SEQUENCE LISTING”

Separately attached and incorporated by reference are CD-ROMs labeled COPY 1 and COPY 2.

### BACKGROUND OF INVENTION

Typically an initial lender, whether it is a bank, financial institution, other loan generator, or licensed broker, meets a borrower and based on analyzing the credit application as well as evaluating the borrower during the interview process, decides whether to make a residential or commercial loan. Often, after making the loan, the initial lender elects not to service the loan itself, and sometimes, elects to continue to service the loan for a fee, but still elects to sell the loan to another financial institution. Home loans are sold as “whole loans” on the whole loan exchange, also referred to as the whole loan marketplace.

Federal legislation promotes, and in some instances requires, the buying and selling of home loans between financial institutions. In particular, the purpose of the Community Reinvestment Act (CRA), 29 U.S. C. §§2901 et seq, is to eliminate discrimination in lending by requiring banks and financial institutions to make/carry home loans in their own local communities. The lenders' current practice of balancing their loan portfolios to insure compliance with the law involves telephone calling and emailing other institutions to purchase/acquire loans. Similarly, commercial loans are also subject to transfer between the initial and subsequent lenders. In either event, the practice is cumbersome and labor intensive. Since there is no borrower interview during the re-sale process, the acquiring lender must decide whether the residential or commercial loan is in its own community so that servicing the loan will satisfy the CRA law's requirements. Before completing the purchase of the loan, the acquiring lender must perform a metric analysis of the data obtained from the initial lender to evaluate whether it is a viable loan.

Since transactions involving buying and selling residential and commercial loans could amount to the sale of securities, and to preserve borrower privacy, the invention permits access to verified lender representatives and licensed brokers only, through password protection, encryption, and fire walls.

The invention comprises a method and apparatus enabling selling lenders and buying lenders to access the same pool of residential and commercial loans, with the goals of decreasing transaction costs and processing time, and the corresponding result of increasing marketability of loans to promote compliance with the CRA law. Reduction of transaction costs will have an ameliorative effect on the home market and home prices by making more money available for loans. It will also improve commercial transactions.

### SUMMARY OF INVENTION

Selling lenders place residential and commercial loans that they wish to transfer on an internet platform through local computer terminals. Acquiring lenders access the same platform through their terminals. The seller's listed loans can be searched by (1) location including state, county, municipality, MSA (metropolitan statistical area), census tract and/or zip code; (2) CRA, borrower income vs. HUD median and HUD median vs. MSA median; (3) credit rating, such as FICO scores; (4) loan size and unpaid principal balance of the loan; (5) loan type, including, term length, document type for origination, occupancy type, purpose such as refinance, refinance with cash out, or purchase; (6) loan to value percentage; and, (7) borrower income. The search can also include performance characteristics, such as repayment history.

An asking price is not explicitly defined by the seller. The asking price is based on unpaid principal balance, interest rate, loan type (FNMA, GNMA, etc.), as well as term (10 yr, 15 yr, 30 yr, etc.). My invention provides marketplace information to assist buyer and seller in agreeing on a price.

The loans on the internet platform are now available for competitive bidding. Parameters for bidding are set, such as opening time, closing time, and conditions, if any. For privacy reasons, at the initial stage, the actual borrower's personal identification is masked.

Acquiring lenders access the pool of available residential and commercial loans on the internet platform through local computer terminals. Those acquiring lenders who are interested in a particular loan based on geographical area or based on other features, may then place bids on the available loans.

The bids on a particular loan are reviewed by the selling lender. The selling lender can evaluate the bid for price or other determinative characteristics, such as size, or terms and conditions of the proposed bid. The selling lender can then select the winning bid and provide electronic notification. The details of the sale, including transfer of deeds of trust, promissory notes and payment can be accomplished in the fashion customary to one skilled in the industry.

### BRIEF DESCRIPTION OF THE DRAWINGS

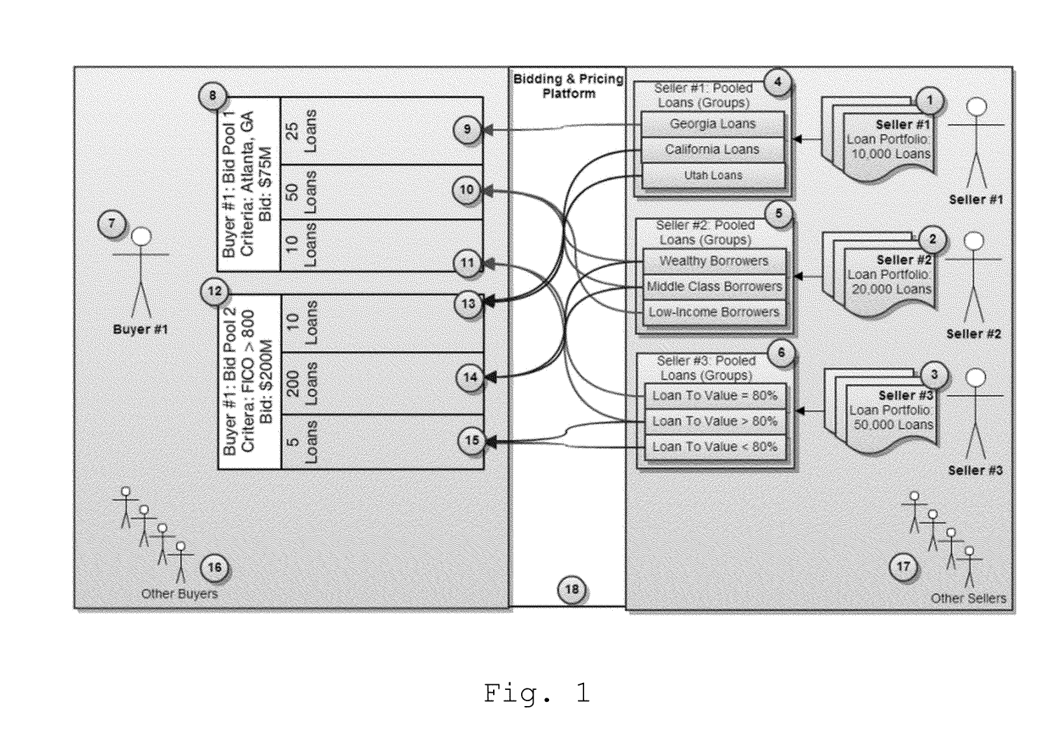

Attached as FIG. 1 is a basic flow chart showing the inputs by selling lenders and acquiring/buying lenders.

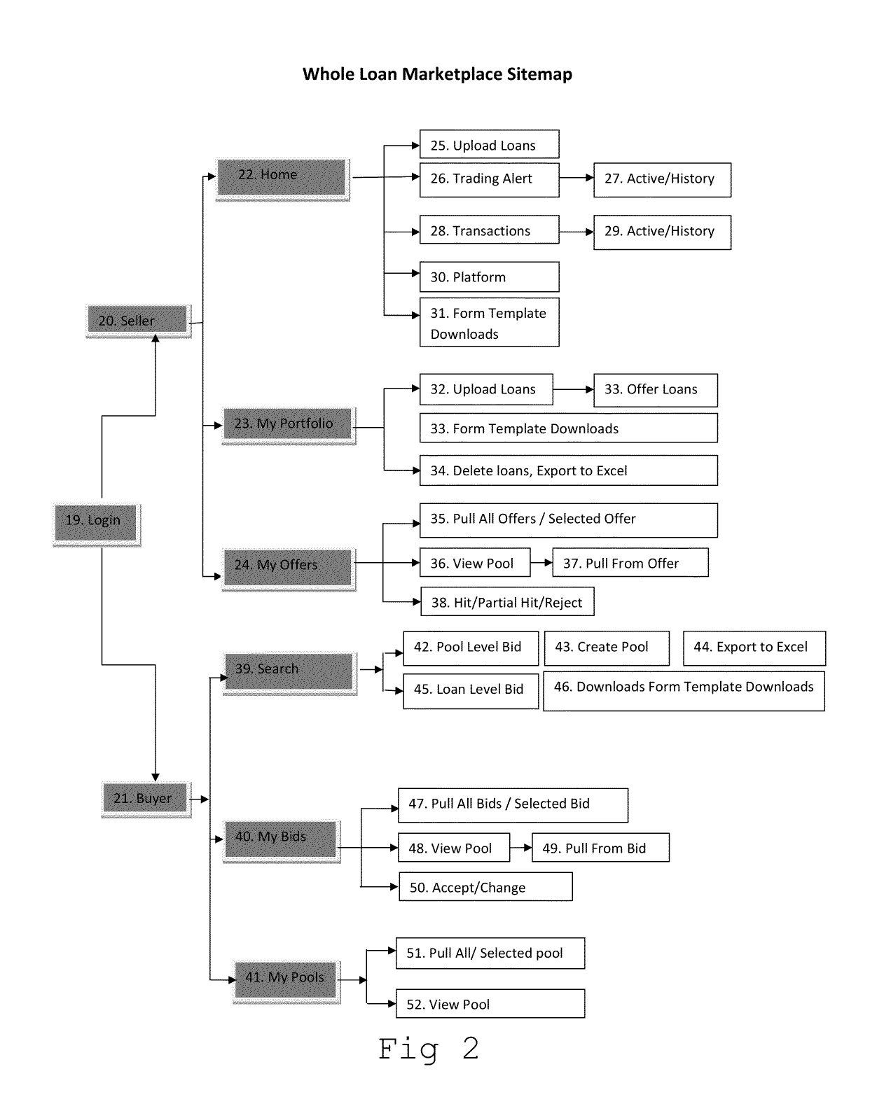

Attached as FIG. 2 is the site map which explains the functionality within the marketplace.

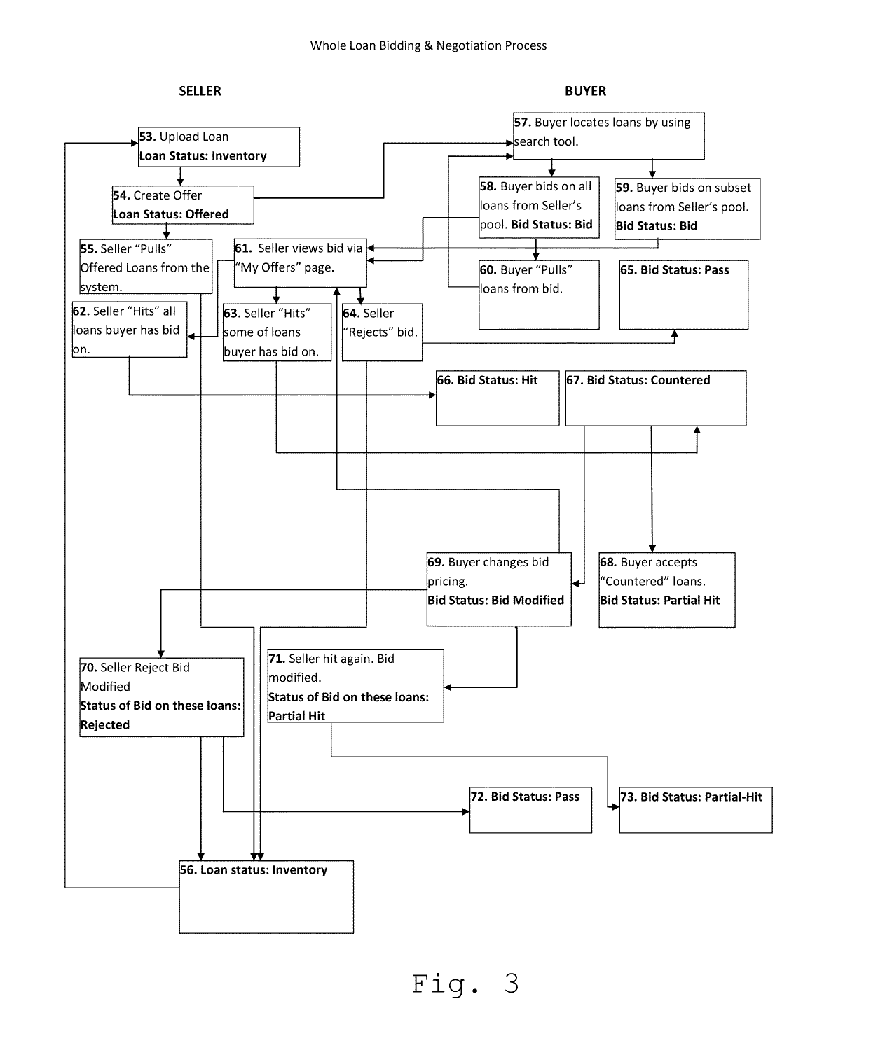

Attached as FIG. 3 is the bidding and negotiation process to establish the price for the sale of whole loans.

### DETAILED DESCRIPTION OF DRAWINGS

The Invention is explained by example loan sales transactions depicted on the Drawings. The example sales are not meant to be all inclusive, but rather provide an explanation of how the apparatus and method can be used. FIG. 1 shows an overview of the sales process between buyers and sellers of loans.

Seller #1 enters the bidding and pricing platform and loads any number of loans into its online portfolio. In this particular, demonstrative example, Seller #1 uploads a spreadsheet containing 10,000 loans that it owns. Seller #2 enters the platform and loads any number of loans into its online portfolio. In this example, Seller #2 uploads a spreadsheet containing 20,000 loans that it owns. Seller #3 enters the platform and loads any number of loans into its online portfolio. In this example, Seller #3 uploads a spreadsheet containing 50,000 loans that it owns.

Seller #1 organizes its loans into three separate groups, based on certain characteristics of the loans. In this example, Seller #1 chooses to organize its loans based on geography, into three separate US States: Georgia, California, and Utah. Seller #2 organizes its loans into three separate groups, based on certain characteristics of the loans. Seller #2 chooses to organize its loans based on borrower information, into three separate demographics: Wealthy, Middle Class, and Low-Income Borrowers. Seller #3 organizes its loans into three separate groups, based on certain characteristics of the loans. Seller #3 chooses to organize its loans based on equity and loan information, into three separate categories: Loan-to-Value=80%, Loan-to-Value>80%, and Loan-to-Value<80%.

Buyer #1 accesses the platform and begins its search for loans to purchase. Buyer #1 initiates a search for loans in Atlanta, Ga. This search returns loans from Sellers #1, #2 and #3, as illustrated by the Arrows #9, #10 and #11. Buyer #1 reviews these loans, and can filter any loans from the search results that it does not want to purchase by deselecting each unwanted loan from the search result. Buyer #1 is provided with marketplace data, approximate value, and pricing information by the platform (additional details are discussed below at #18). Using this information, Buyer #1 then places a bid of $75 million for the remaining loans in which it is interested. Note that in this step, each Seller #1, #2 or #3, will have the ability to accept, reject, or counter Buyer #1's offer, with a different price. Buyer #1 can then respond by removing its bid, agreeing to the offer, or modifying its bid. This sales price negotiation may continue multiple times.

Buyer #1's search results contains 25 loans from Seller #1, since Seller #1 has whole loans on the platform for borrowers in the State of Georgia. Some of the Georgia loans are for borrowers in Atlanta, and are therefore displayed in the Buyer's search results. Buyer #1's search results contain 50 loans from Seller #2, since Seller #2 has whole loans on the platform which are for wealthy, middle class, and low-income borrowers. Seller #2 has loans for borrowers in Atlanta, in all three of these income classification categories, so loans from each of these three groups are returned in Buyer #1's search results. Finally, Buyer #1's search results contain 10 loans from Seller #3, since Seller #3 has whole loans on the platform which are for loans with differing loan-to-value calculations. Seller #3 has loans for borrowers in Atlanta, in all three of these loan classification categories, so loans from each of these three groups are returned in Buyer #1's search results.

Buyer #1 chooses to do another search for all loans in the United States, where the borrowers' credit scores (FICO score) are greater than 800. This returns loans from all Sellers #1, #2 and #3, as illustrated by the Arrows #13, #14 and #15. Buyer #1 reviews these loans, and can filter any loans from the search results that it does not want to purchase by deselecting each unwanted loan from the search result. Buyer #1 is provided with marketplace data, approximate value, and pricing information by the platform (additional details discussed below at #18). Using this information, Buyer #1 then places a bid of $200 million for the remaining loans in which it is interested. Note that in this step, each Seller #1, #2 or #3, will have the ability to accept, reject, or counter Buyer #1's offer with a different price. Buyer #1 can then respond by removing its bid, agreeing to the offer, or modifying its bid. This sales price negotiation may continue multiple times.

Buyer #1's search results contain 10 loans from Seller #1, since Seller #1 has whole loans on the platform with borrowers in California and Utah with FICO scores above 800. Buyer #1's search results contain 200 loans from Seller #2, since Seller #2 has whole loans on the platform for wealthy and middle class borrowers with FICO scores above 800. Buyer #1's search results contain 5 loans from Seller #3, since Seller #3 has whole loans on the platform which have borrowers with FICO scores above 800. Seller #3′s loan-to-value categorization of loans in the portfolio does not have any direct correlation to the borrower's FICO score, yet loans from Seller #3 are displayed in the search results since some of these loans have a borrower with a FICO score greater than 800.

There can be any number of other Buyers #16 on the platform, who are performing search and bidding activities just like Buyer #1. These other buyers may be competing with one another to get the best value for the loans on which they are bidding. There can be any number of other sellers #17 on the platform, which are performing similar activities to Sellers #1, #2 and #3. These sellers may be competing with one another on the platform to get the best terms of highest sales price for their loans.

The bidding and pricing platform #18 provides both buyer and seller with marketplace information to assist in rapidly performing multiple iterations and calculations to save time and money. The marketplace information includes industry benchmark data, to help both buyer and seller negotiate an acceptable deal, based on current trends and historical exchanges in the marketplace.

On FIG. 2, I explain the actual functions that will be performed by loan sellers and buyers in the marketplace as the functions appear on individual computer screens.

The login point #19, is where each user—buyer or seller—enters his or her credentials for authentication and access to the marketplace. The primary features for Seller #20 are Home #22, My Portfolio #23 and My Offers #24. Although, Seller #20 has access to Buyer #2 l′s features, these three areas are of most interest to Seller #20.

Home #22 is where both buyers and sellers can review alerts and statistics which relate to their objectives. Both buyers and sellers access notifications about recent activity relating to their bids on this page. Upload Loans #25 provides an interface for the seller to upload spreadsheets that contain loan information. The system will update existing loans in the platform when they exist, and it will add new loans to the system from the spreadsheet if they have not already been uploaded.

Trading Alert #26 displays a summary of all recent trading alerts which relate to the user. Trading Alert Active/History #27 allows the user to toggle between ‘live’ alerts and historical alerts.

Transactions #28 displays a summary of all recent transactions which relate to the user. Transactions Active/History #29 allows the user to toggle between ‘live’ transactions and historical transactions—completed sales.

Platform #30 provides various statistics about the marketplace and usage of the platform. Users can see the volume and price of loan trades on a specified time interval.

Form Template Downloads #31 is where users can download templates of various types for use in the system (i.e., spreadsheets for organizing and uploading loan data).

My Portfolio #23 is the area where sellers can view all loans that they have uploaded into the system. These loans are displayed in a grid, similar to a spreadsheet, for easy viewing and organizing.

Upload Loans #32 is a feature for sellers to upload new loans into the system. Offer Loans #33 is the action required for loans to be flagged as available to buyers, and ready for active bidding.

Form Template Downloads #33 performs the same function as Form Template Downloads #31, but under My Portfolio #23.

Delete Loans, Export to Excel #34 has two features which allow the sellers to manage their portfolios within the site. They may delete loans that they had previously uploaded, or export a list of their loans for off-line handling and review.

Pull All Offers/Selected Offers #35 enables the sellers to remove groups of loans from active bidding status under My Offers #24. View Pool #36 provides sellers with drill-down visibility into a group of their loans, for management and review. Once again sellers have the option at Pull from Offer #37, to remove any loan(s) from bidding.

Hit/Partial Hit/Reject #38 is a negotiation feature which enables sellers to find a suitable price with buyers. The term ‘Hit’ is synonymous with ‘sold’ on this platform. ‘Partial Hit’ means that some loans have been sold while others have not. ‘Rejected’ means that seller has rejected a buyer's bid.

Buyers #21 have three areas which are of primary interest to them, comprising Search #39, My Bids #40 and My Pools #41.

Search #39 is the primary tool for buyers to find loans to bid on. Buyers may use any number of metrics for locating loans, including but not limited to: geographical area, borrower information and loan data.

Under Search #39, are several functions. Pool Level Bid #42 allows buyers to bid on a group of loans. Create Pool #43 is a feature which allows buyers to save search results for future viewing, but without placing a bid on the loans. Export to Excel #44 is a feature which allows buyers to take loan information off-line for review and analysis. Loan Level Bid #45 allows buyers to bid on individual loans. Form Template Downloads #46 provides various templates that buyers can use to interact with the system.

Within My Bids #40, buyers can review active and historical bids, and negotiate with sellers. Pull All Bids/Selected Bids #47 permits a buyer to retract active bids if loans have not been awarded to the buyer.

View Pool #48 is used for viewing a group of loans on which bids have been made. Pull from Bid #49 allows for removal of a specific bid. Accept/Change #50 is a function whereby a buyer can accept counter-offers from sellers, or change the bid and counter a seller's proposal with a new bid.

My Pools #41 is for viewing previously saved search results. Pull All/Selected Pool #51 is a management tool for handling loans in a previously saved search result. View Pool #52 is drill-down visibility for buyers to inspect loans that were previously saved to this particular area.

Now turning to the actual process of computerized bidding and negotiating for the sale of whole loans, I explain the process in FIG. 3.

Upload Loans #53 is the initial step for a seller to commence using the platform. The seller must upload a spreadsheet of loan data for loans to be sold on the platform. When the loans are uploaded, they are flagged with the status of ‘Inventory.’ Loans with ‘Inventory’ status are not visible to any other buyers or sellers on the platform and are not ready for bidding.

Create Offer #54 is where the seller presents the loans which have been uploaded #53, by flagging them with ‘Offered’ status in order for buyers to find and bid on them. Loans which are not placed in ‘Offered’ status remain in ‘Inventory’ status.

Seller may remove ‘Offered’ status loans from active bidding by using the ‘Pulls” #55 ‘Offered’ status feature. Loans which have been pulled from ‘Offered’ status return to ‘Inventory’ status.

Buyers locate loans by using search tools and features #57. A buyer may place a bid on any number of loans its selects, including an entire group of loans from a single seller (referred to as a seller's ‘Pool’ of loans, see #36 on FIG. 2). The status of the loans is changed to ‘Bid’ #58. Or instead of bidding on an entire ‘Pool,’ a buyer may place a bid on any number of loans it selects, including any number of singular loans, and the status of the loans is changed to ‘Bid’ #59.

Buyer has the option to revise its bid, by removing loans from its bid, even after the ‘Bid’ has been entered but prior to acceptance, by using the ‘Pulls’ #60 feature.

Seller receives notification #61 that a buyer has placed a bid on loans in its portfolio and can review the details of the bid. Seller responds to buyer's bid by choosing ‘Hit’ or ‘Sell’ all loans to buyer #62. Or seller may choose to ‘Hit’ or ‘Sell’ only some loans on which buyer has bid #63. Seller simply opts not to sell all of the loans to buyer at the bid price. Finally, seller may ‘Reject’ #64 the entire bid. Seller may leave the loans on the platform or return them to ‘Inventory’ #53. Where the seller chooses ‘Reject’ #64 but does not return the loans to ‘Inventory,’ then the seller causes the bid to be in ‘Pass’ #65 status, awaiting further action by buyer.

If the seller chooses to sell all loans to buyer as per Bid #62, then the loans are flagged as sold #66, and no longer available for bidding. If the seller chooses to sell only some of the loans to buyer #63, then the bid status of the loans is flagged as ‘Countered’ #67, which gives the buyer an opportunity to respond to seller's counter-offer. Buyer may either change its price #69 placing the bid status in ‘Bid Modified,’ or accept seller's counter-offer to purchase only some of the loans, flagged as ‘Partial Hit’ #68.

When the seller has chosen to sell only some of the loans and the buyer agrees #68, then this closes the negotiation loop between the two parties. When the seller chooses to sell only some loans at the original bid, then buyer may re-bid in response to the counter-offer #69, and the negotiation process continues between the two parties. Of course, each re-bid or counter-offer creates a new offer, and the seller then has the right to walk-away, placing the loans in the status of ‘Rejected’ #70. When rejection occurs, the buyer is notified of the status of the bid under ‘Pass’ #72. Or the parties may agree to sale of some loans, placing the loans in the status of ‘Partial Hit’ #71. Similarly, the buyer is notified of partial purchase #73.

The above description of the preferred embodiment of the present invention has been presented for the purposes of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims.

I claim:

1. A computer driven method comprising:
receiving input of data related to residential and commercial loans from a programmable processor,
providing means to evaluate the data by location, including state, county, municipality, MSA (metropolitan statistical area), census tract and/or zip code, at other terminals,
selecting the particular loans for purchase/acquisition, and
allowing for confirmation of the transaction.

2. The method of claim 1, sorting data by CRA, borrower income vs. HUD median and HUD median vs. MSA median.

3. The method of claim 1, sorting data by credit rating, such as FICO scores, loan size and unpaid principal balance of the loan.

4. The method of claim 1, sorting data by loan type, including, term length, document type for origination, occupancy type, purpose such as refinance, refinance with cash out, or for purchase.

5. The method of claim 1, sorting data by loan to value percentage and/or borrower income and performance characteristics, such as repayment history.

6. A non-transitory computer program, comprising a machine-readable medium for storing instructions that, when executed by at least one programmable processor, causes that processor to perform operations comprising:
receiving input of data related to residential and commercial loans from discrete sources,
providing means to evaluate the data by location, including state, county, municipality, MSA (metropolitan statistical area), census tract and/or zip code, at other terminals,
selecting the particular loans for purchase/acquisition, and
allowing for confirmation of the transaction.

7. The program of claim 6, allowing for sorting data by CRA, borrower income vs. HUD median and HUD median vs. MSA median.

8. The program of claim 6, allowing for sorting data by credit rating, such as FICO scores, loan size and unpaid principal balance of the loan.

9. The program of claim 6, allowing for sorting data by loan type, including, term length, document type for origination, occupancy type, purpose such as refinance, refinance with cash out, or for purchase.

10. The program of claim 6, allowing for sorting data by loan to value percentage and/or borrower income and performance characteristics, such as repayment history.
